(19) United States
(12) Patent Application Publication
(10) Pub. No.: US 2008/0256295 A1
(43) Pub. Date: Oct. 16, 2008

(54) Method of Increasing Boot-Up Speed

(75) Inventors: Nicolaas Lambert, Eindhoven (NL); Robert Jochemsen, Eindhoven (NL); Wilhelmus Franciscus Johannes Fontijn, Eindhoven (NL); Adrianus Johannes Maria Denissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,220

(22) PCT Filed: Jan. 3, 2005
(86) PCT No.: PCT/IB05/50007

§ 371 Date: Jul. 17, 2006

(30) Foreign Application Priority Data
Jan. 21, 2004 (EP) 04100183.5

(51) Int. Cl. G06F 9/445

(52) U.S. Cl. 711/118

(57) ABSTRACT

There is provided a method of increasing boot-up speed in a computer system (10). The system (10) includes computing devices (20) for processing data and a data store (60) coupled thereto for providing data to and receiving data from the devices (20). The store (60) is operable to write and/or read data in several regions (T1, T2, T3) of a data medium (200). Access between the regions is subject to associated jump delays (SK1/2, SK2/3; SK1/3, SL3/2). The store (60) includes a cache (320) for temporarily storing data read from and/or for writing data to the medium (200). On initial boot-up of the system (20), a log is made of a sequence in which the regions (T1, T2, T3) are accessed. Moreover, on subsequent boot-up of the system (10), the log is used to store data read from the medium (200) temporarily in the cache (310, 320) so as to provide for a more temporally efficient sequence of accessing the regions (T1, T2, T3) for speeding up said subsequent boot-up.

The present invention relates to methods of increasing boot-up speed in computer systems; in particular, but not exclusively, the invention concerns a method of increasing boot-up speed by compiling a record of file-requests at start-up of a computer system and using the record to predict a read sequence during subsequent start-up of the computer system to optimise file request and retrieval sequences and advanced caching methods. Moreover, the present invention also relates to computer apparatus and/or sub-components thereof arranged to function according to the method of the invention.

Contemporary computer systems usually comprise one or more processors, random access memory and non-volatile memory. The non-volatile memory is often implemented as one or more electromechanical devices, for example magnetic hard disk drives (HDD) which utilize one or more mechanically actuated pickup devices to record data on and/or access data from one or more disk-like magnetic planar data carriers which are rotatable in operation relative to the one or more pickup devices. It is well known that such HDD drives are susceptible to providing relative long data access times on account of a need to accelerate the one or more disk-like data carriers to required rotation speed relative to the one or more pickup devices and also to actuate the one or more pickup devices to suitable positions relative to the one or more data carriers to identify desired blocks for data retrieval therefrom and/or for data recording thereat. As a consequence of such access delay, contemporary computer systems often require several tens of seconds at initial energization and/or after a reset, namely “boot-up”, to load an operating system (OS) and desired software applications into the random access memory.

Reduction in boot-up time in contemporary computer systems is a known problem and several strategies have been proposed. In a United States patent application no. US2002/0156970, there is described a computer system including a non-volatile memory positioned between a disk controller and a disk drive storing a boot-up program. Upon an initial boot-up sequence, for example a first time the computer is energized, the boot-up program is loaded into a cache of the non-volatile memory. Subsequent boot-up sequences retrieve the boot-up program from the cache which provides considerably faster data access than the disk drive itself, thereby providing faster boot-up. Moreover, validity of data stored in the cache is maintained by monitoring cache misses, and/or by monitoring writes to the disk such that a write to a sector of the disk which is also held in the cache results in a cache line for that sector being invalidated until such time as the cache is updated from the disk drive. A filter driver is provided for monitoring write operations to the disk and thereby determine if a cache line is invalidated.

Thus, contemporary hard disk drives (HDD) are arranged to utilize heuristic caching strategies for reading data, for example at “boot-up”. For example, a contemporary HDD is arranged:

(a) to search for patterns in the read requests that it receives;
(b) to try to predict what information will be requested next; and
(c) reads the predicted information from a data storage medium of the HDD into a HDD internal cache buffer.

Thus, most of the time, the HDD will quickly read-ahead some contiguous data past that of a current request for data received at the HDD in a hope that a request for that contiguous data will arrive shortly.

Modern operating systems (OS) are arranged to organize data in system memory such that HDD data traffic is minimized, and to attempt to organize data in the HDD such that requests for data therefrom can be serviced faster. However, such organisation of data is found in practice to be only partially successful at rendering data retrieval more rapid. Thus, during boot-up, a modern computer system still takes considerable time to complete a boot-up procedure and initialize its operating system (OS).

The inventors have therefore envisaged a more effective solution to a problem of boot-up speed and have devised an alternative method of increasing boot-up speed.

An object of the present invention is to provide for more rapid boot-up in computer systems.

A further object of the present invention is to provide for more rapid boot-up in a more complex computer system susceptible to multi-boot.

Yet a further object of the present invention is to provide a hard disk drive data storage device susceptible arranged to provide more rapid boot-up.

According to a first aspect of the present invention, there is provided a method of increasing boot-up speed in a computer system, comprising the steps of:

(a) arranging for the system to include computing means for processing data, and data storing means coupled to the computing means for providing data to and receiving data from the computing means, the storing means being operable to write and/or read data in a plurality of spatially disposed regions of at least one data medium thereof wherein access between the spatial regions is subject to one or more associated jump delays;
(b) arranging for the storing means to including data caching means therein for temporarily storing data read from and/or for writing data to said at least one data medium;
(c) on initial boot-up of the system, making at least one log of a temporal sequence in which one or more spatially disposed regions of the at least one data medium (200) are accessed; and
(d) on one or more subsequent boot-ups of the system, using the at least one log to store data read from the at least one data medium temporarily in the data caching means so as to provide for a more temporally efficient sequence of accessing the spatially disposed regions so as to speed up said one or more subsequent boot-ups.

The invention is of advantage in that it is capable of resulting in the computer system exhibiting more rapid boot-up.

The log is of benefit in that is susceptible to being used to predict future data content requests and thereby improve caching strategy.

Preferably, the method comprises a further step of arranging for the system to adopt an heuristic approach, for example as known in the art, for accessing the spatially disposed regions when, on said one or more subsequent boot-ups, a sequence of accessing the spatially disposed regions instructed by the computing means digresses from that which is recorded in said at least one log. Use of such a heuristics approach enables the system not only to cope with complex but repetitive file access sequences efficiently, but also to handle more optimally a situation where a complex and more unpredictable file access sequence is encountered.

Preferably, in the method, there are several logs corresponding to a plurality of temporal sequences, and the method includes a further step of arranging for the system to switch between the logs depending upon which of the temporal sequences the system elects to adopt on boot-up. More preferably, the system is arranged to switch dynamically between the logs when executing boot-up; in other words, the system is preferably able to jump between the temporal sequences dynamically during boot-up in response to differences arising between an initial adopted sequence expected and demands for data from the computing means.

Preferably, in the method, the storing means is implemented as at least one hard disk drive (HDD) provided with associated local computing means for implementing the data caching means, for supervising recording of the one or more logs and for executing their one or more sequences in response to boot-up of the system. Such an implementation of the method is of advantage in that it enables the method to be implemented locally within the at least one disk drive, thereby achieving compatibility with earlier disk drives not configured to execute the method of the invention.

According to a second aspect of the present invention, there is provided a computer system arranged to provide a more rapid boot-up, wherein:

(a) the system includes computing means for processing data, and data storing means coupled to the computing means for providing data to and receiving data from the computing means, the storing means being operable to write and/or read data in a plurality of spatially disposed regions of at least one data medium thereof wherein access between the spatial regions is subject to one or more associated jump delays;
(b) the storing means includes data caching means therein for temporarily storing data read from and/or for writing data to said at least one data medium;
(c) the system is operable on initial boot-up thereof to make at least one log of a temporal sequence in which one or more spatially disposed regions of the at least one data medium are accessed; and
(d) the system is operable, on one or more subsequent boot-ups thereof, to use the at least one log to store data read from the at least one data medium temporarily in the data caching means so as to provide for a more temporally efficient sequence of accessing the spatially disposed regions so as to speed up said one or more subsequent boot-ups.

Preferably, the system is further operable to adopt an heuristic approach for accessing the spatially disposed regions when, on said one or more subsequent boot-ups, a sequence of accessing the spatially disposed regions instructed by the computing means digresses from that which is recorded in said at least one log.

Preferably, the system is arranged to record several logs corresponding to a plurality of temporal sequences, and arranged to switch between the logs depending upon which of the temporal sequences the system elects to adopt on boot-up.

Preferably, the system is arranged to switch dynamically between the logs when executing boot-up.

Preferably, in the system, the storing means is implemented as at least one hard disk drive (HDD) provided with associated local computing means for implementing the data caching means, for supervising recording of the one or more logs and for executing their one or more sequences in response to boot-up of the system.

According to a third aspect of the present invention, there is provided a hard disk drive for use in a computer system to provide a more rapid boot-up therein, wherein:

(a) the system includes computing means for processing data, and the disk drive coupled to the computing means for providing data to and receiving data from the computing means, the disk drive being operable to write and/or read data in a plurality of spatially disposed regions of at least one data medium thereof wherein access between the spatial regions is subject to one or more associated jump delays;
(b) the disk drive includes data caching means therein for temporarily storing data read from and/or for writing data to said at least one data medium;
(c) the system is operable on initial boot-up thereof to make at least one log of a temporal sequence in which one or more spatially disposed regions of the at least one data medium are accessed; and
(d) the system is operable, on one or more subsequent boot-ups thereof, to use the at least one log to store data read from the at least one data medium temporarily in the data caching means so as to provide for a more temporally efficient sequence of accessing the spatially disposed regions so as to speed up said one or more subsequent boot-ups.

It will be appreciated that features of the invention are susceptible to being combined in any combination without departing from the scope of the invention.

Embodiments of the invention will now be described, by way of example only, wherein:

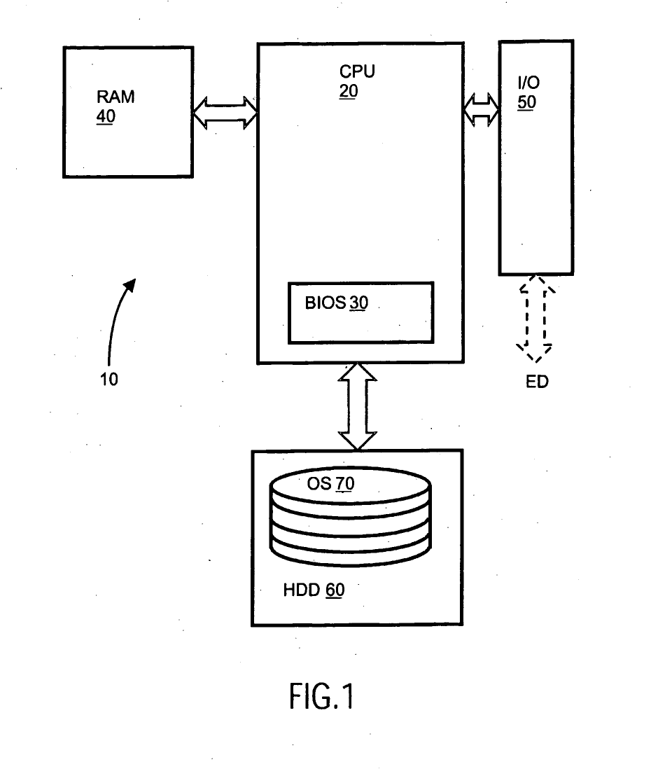

FIG. 1 is an illustration of a computer system comprising a processor (CPU) including a BIOS software, the processor (CPU) being coupled to an associated random access memory (RAM, to an input/output unit (I/O) and also to a hard disk drive (HDD) for non-volatile data storage and retrieval, the drive (HDD) accommodating operating system software (OS) and one or more software applications compatible with the operating system (OS) and executable on the processor (CPU);

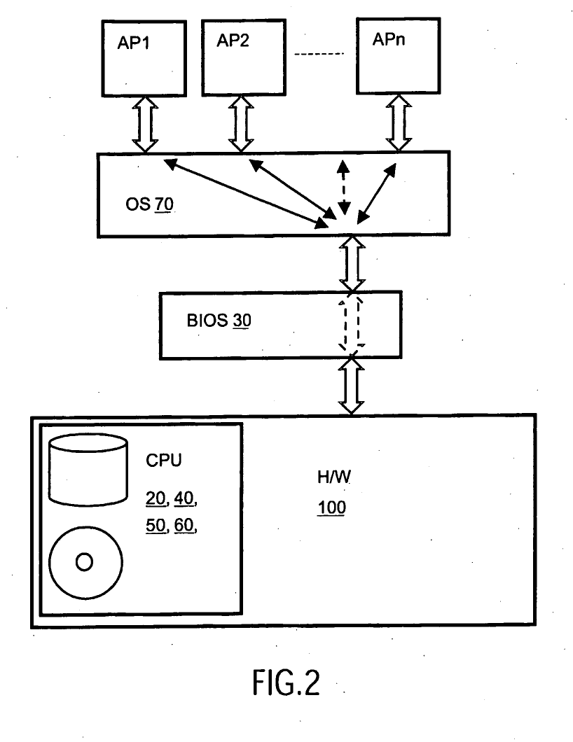

FIG. 2 is an illustration of a manner in which software is executable on the computer system of FIG. 1;

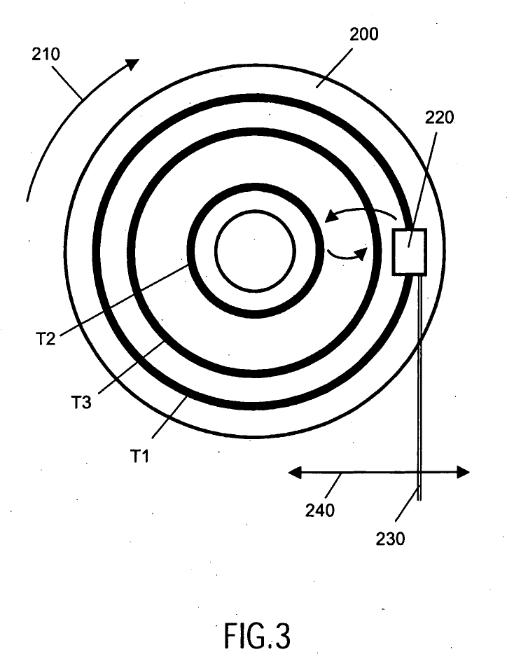

FIG. 3 is an illustration of a disk-like data storage medium of the hard disk drive (HDD) of FIG. 1 together with its associated read/write pickup device and its actuation arrangement, the medium including a plurality of data tracks accessible by way of the pickup device;

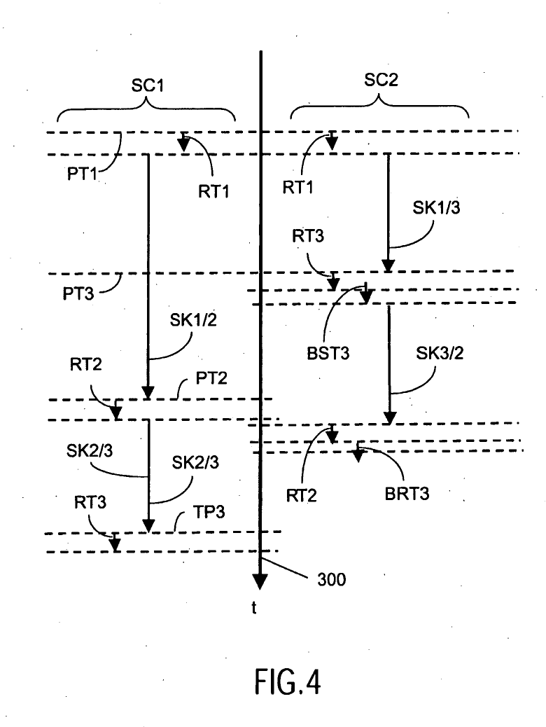

FIG. 4 is a temporal flow chart illustrating access time to the plurality of data tracks shown in FIG. 3 for difference operating scenarios (SC1, SC2) of the hard disk drive (HDD) shown in FIG. 1; and

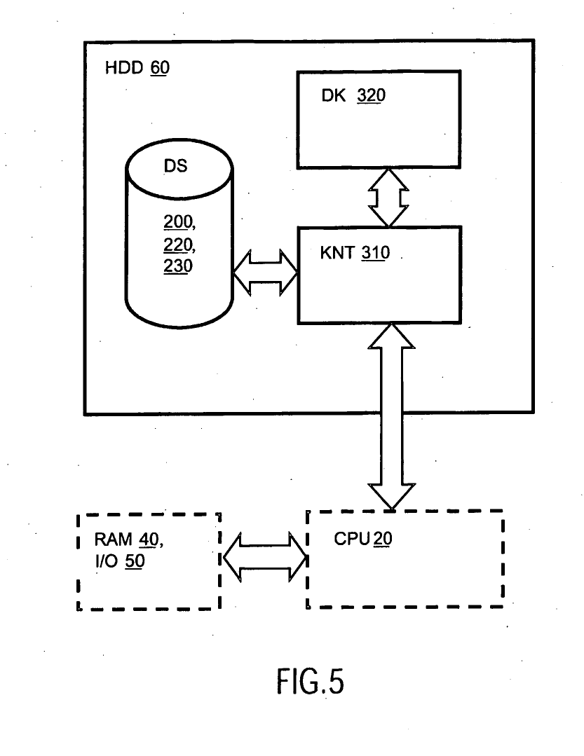

FIG. 5 is an illustration of an internal arrangement of component parts of the hard disk drive shown in FIG. 1.

Experimentally, the inventors have found that in contemporary personal computer (PC) environments supported by associated hard disk drive (HDD) memory, most requests to the HDD memory are relatively small, namely very often 4 kBytes. Such environments include, for example, Linux, Windows NT and Windows XP although other environments are known. The requests for small amounts of data are generally extremely difficult for HDD drives to predict. The inventors believe these requests for small amounts of data are due to a computer host's on-demand-paging and frequent accesses to file system administration, for example to contemporary FAT (DOS-type systems), NTFS (Windows NT and more recent Windows variants) and EXT2 (UNIX/LINUX). As a consequence, the inventors have found that HDD read performance is virtually completely dominated by seeking time, for example time for moving reading pickup devices relative to rotating data carrying disk-like media in such HDD, and rotational latency, for example time to accelerate the disk-like data medium; data transfer time to and/or from HDD drives is substantially negligible in comparison. A period that it makes to boot-up and initialize an operating system (OS) for a contemporary computer is mostly dominated by first HDD rotational acceleration, namely “spin-up” which be in the order of 10 seconds, and then subsequent temporal latencies for data read requests.

The inventors have envisaged that a HDD drive of a computer system can be arranged to record, namely to make a log of, a data request sequence received by the HDD drive during an initial system start-up procedure immediately after power-up. In such circumstances, the system often will not have loaded its basic input/output system (BIOS) software and its operating system (OS) and any software applications dependent thereon. The aforesaid log is beneficially implemented with relatively little overhead to the computer system. During a subsequent time the system is subject to boot-up, the HDD drive can use the record of the data request sequence to predict request for data to a high degree of confidence and thereby optimize data caching therein for optimizing performance of the HDD drive.

The inventors have appreciated that the data request sequence during boot-up and operating system (OS) initialization is often highly reproducible although complex in nature. By relying on the aforesaid log of the data request sequence, the HDD drive has an advanced indication of data which is to be retrieved from disk-like data medium of the drive. Moreover, the inventors have also identified that many requests for data from the HDD drive relate to data recorded in small areas which are spatially clustered together on the HDD drive, these small areas not being ordered for ensuring best HDD drive performance. Thus, the HDD drive is susceptible to saving considerable seek and rotational temporal latency by ordering its internal requests in a manner for achieving best performance.

Thus, the inventors propose a method of increasing boot-up speed which is easy to implement and which potentially can be implemented with modest resources as it represents an extension of current computer system practice. Moreover, the method is susceptible to being implemented independently of the operating system (OS) and basic input/output system (BIOS) of a computer system. Furthermore, the method is capable of being implemented locally and does not require special collaboration with the OS and BIOS of the computer system.

Additionally, the method is robust and does not prejudice operation of other parts of the computer system; for example, in a multi-boot type of computer system, or a computer system that is often required to change configuration, the method may not always be able to increase boot-up speed of the computer system but will, conversely, not substantially slow down operation of the computer system when switched to a multi-boot mode of operation. Preferably, in a multi-boot scenario, as soon as a request sequence at boot-up deviates considerably from an expected data request sequence, for example as recorded in the aforementioned log, the HDD drive can be arranged simply to revert to a more conventional heuristic mode of operation in such circumstances.

The inventors have appreciated that the method of the invention is easier to implement than known approaches to increasing boot-up speed. Such known methods include reallocating data on the HDD disk so that most requests for data during start-up, namely boot-up, are contiguous. Reallocating data on the HDD disk is a viable approach but is more technically involved on account of requiring physical movement of potentially large amounts of data and associated bookkeeping data, and is less suitable for multi-boot computer systems.

In order to further describe the present invention, embodiments thereof will now be described with reference to FIGS. 1 to 5.

Referring firstly to FIG. 1, there is shown a computer system indicated generally by 10. The system 10 includes a processor (CPU) 20 comprising basic input/output software (BIOS) 30, for example stored on a read only memory of the processor 20. Coupled to the processor 20 are a random access memory (RAM) 40 and an input/out unit (I/O) 50 connectable to other external devices (ED). Moreover, the processor 20 is also coupled to a hard disk drive (HDD) 60 which is operable to provide for non-volatile data storage and retrieval. The disk drive 60 is arranged to store an operating system (OS) 70 together with one or more software applications executable on the processor 20 and compatible with the operating system 70.

Operation of the computer system 10 will now be described in overview with reference to FIG. 1. On initial boot-up of the system 10, or after a reset of the system 10, the processor 20 accesses firstly the BIOS software 30 which defines a basic configuration of hardware of the processor 20, for example a status for registers therein and an address reference for accessing the operating system 70. Accessing the BIOS software 30 causes the processor 20 to retrieve the operating system software 70 from the disk drive 60 and load it into the random access memory 40; the operation system software 70 includes references to sub-files which cause the disk drive 60 to seek blocks of data from diverse regions of storage media present in the drive 60. The processor 20 then commences to execute the operating system (OS) 70 software which causes the processor 20 to create an environment for executing one or more user-selected software applications also stored on the drive 60 which the processor 20 is operable to access to load from the drive 60 into the memory 40 and then execute in the processor 20.

In the process of loading the operating system software (OS) from the drive 60, the drive 60 is caused to follow a complex data searching sequence which is, despite its complexity, substantially similar each time the system 10 is subject to boot-up.

Referring next to FIG. 2, there is shown an operating interrelationship between hardware 100 of the system 10 and the aforementioned BIOS 30, operating system (OS) software 70 and software applications AP1 to APn where n is an integer. The operating system software (OS) 70 provides an environment for the one or more software applications AP1 to APn, the operating system 70 itself being dependent on the BIOS software to cause the hardware 100 of the system 10 to function. The hardware 100 includes the processor 20, the memory (RAM) 40, the input/output unit (I/O) 50 and the disk drive 60.

Referring to FIG. 3, there is shown a disk-like data storage medium 200 of the drive 60. Preferably, the drive includes one or more of such media 200 depending on data storage capacity desired for the system 10. The medium 200 is substantially a relatively thin planar round disk-like component having a central mounting aperture for coupling to a drive motor (not shown) for rotating the medium 200 in use in a rotational direction as indicated by an arrow 210 relative to a read/write pickup device 220; the pickup device is susceptible to being implemented, for example as a magnetic-type-pickup and/or an optical-type pickup depending on a nature of data recordation on the medium 200. On one or more planar faces of the medium 200 are recorded data tracks comprising sequences of data, for example tracks T1, T2, T3; however, it will be appreciated that the medium 200 is susceptible to including many more tracks than these three tracks, these three tracks being described for purposes of illustrating the present invention. Data blocks correspond to angular sections of the tracks T1, T2, T3.

The pickup device 220 is itself mounted on an actuated support 230 which is movable relative to the medium in a substantially radial direction as indicated by an arrow 240.

In an example scenario, in reading the operating system (OS) 70 data from the drive 60, the pickup device 220 is required by the processor 20 to read from the track T1 near a perimeter of the medium 200, then jump to the track T2 near a central region of the medium 200, and then finally jump to the track T3 which is spatially intermediate between the tracks T1 and T2. Jumps between the tracks T1, T2, T3 may involve substantially rotational delay as the medium 200 until angular sections corresponding to requested data blocks pass by the pickup device 220.

In FIG. 4, there is provided a temporal diagram including an axis (t) 300 denoting progression of time. The diagram shows a first scenario SC1 wherein the pickup device 220 reads data from track T1 during a period RT1 and outputs the data therefrom to the processor 20, whereafter the pickup device 220 is actuated during a jump period SK1/2 from the track T1 to the track T2, whereafter the pickup device 220 reads data from the track T2 during a period RT2 and outputs the data therefrom to the processor 20, whereafter the pickup device 220 is actuated during a jump period SK2/3 to the track T3, whereafter the pickup device 220 reads data from the track T3 during a period RT3 and outputs the data therefrom to the processor 20. The first scenario SC1 represents a standard type of access sequence known in the art.

The inventors have appreciated, for example at boot-up, that a second scenario SC2 is preferable to the first scenario. In the second scenario SC2, the pickup device 220 reads data from the track T1 during the period RT1 and outputs the data therefrom to the processor 20, whereafter the pickup device 220 is actuated during a period SK1/3 to the track T3, whereafter the pickup device 220 reads data from the track T3 during the period RT3 and outputs the data therefrom and stores it in a memory cache of the drive 60 during a period BST3, whereafter the pickup device 220 is actuated during a period SK3/2 to the track 12, whereafter the pickup device 220 reads data from the track T2 during the period RT2 and outputs the data therefrom to the processor 20, whereafter the drive 60 outputs the data stored in the memory cache corresponding to the track T3 to the processor 20.

In practice, the periods RT1, RT2, RT3 are considerably shorter in duration than the jump periods SK1/2, SK2/3, SK1/3 and SK3/2. Moreover, the jump period SK1/3 is considerably shorter than the period SK1/2 rendering the second scenario SC2 more rapid in execution in comparison to the first scenario SC1.

As described in the foregoing, the drive 60 is operable on an initial boot-up to following the first scenario SC1 and record a log of tracks accessed, amount of data retrieved at each track, jump durations and relative spatial juxtaposition of the tracks. Preferably, the log is stored in non-volatile memory of the memory cache, for example battery-backup-powered random access memory which retains its data content during power down of the computer system 10; if required, the log is susceptible to being transferred to private address areas of the drive 60 when the drive 60 is idling and not servicing in use demands for data from the processor 20. On subsequent boot-up of the system 10, the drive 60 accesses the log from the non-volatile memory and determines therefrom that the second scenario CS2 is appropriate and adopts this scenario, thereby enabling the computer system 10 to boot-up more rapidly. It will be appreciated that the second scenario SC2 does not involve rearrangement of data on the medium 200.

In order to implement the second scenario SC2, the disk drive 60 is preferably implemented as illustrated in FIG. 5. The drive 60 comprises a disk drive controller (KNT) 310 for handling data between the media 200 and their associated pickup devices 220 and the processor 20, the controller 310 having a data cache (DK) 320 coupled thereto for storing blocks of data, for example from the track T3 in the second scenario SC2, for decreasing boot-up time in the system 10.

The drive 60 is preferably arranged at boot-up to use a caching approach akin to that illustrated in FIG. 4. However, for example in a multi-boot type scenario where boot-up can vary in amongst a plurality of different boot-up sequences, the drive 60 is preferably arranged to revert to employing a more conventional heuristic type of track access approach.

Where the controller 310 expects from the log a given track sequence and, for example on interrogating the track T1 recording addresses of subsequent tracks to be accessed during boot-up, finds that a different sequence is reed, the controller 310 can be arranged in such circumstances to disregard the log but monitor the different sequence for purposes of updating the log to adopt the different sequence.

Optionally, the controller 310 can store not just the actual read sequence as issued by the processor 20, for example as stored in the track T1, but internally optimize its own access sequence for the media 200 in a cached manner as depicted in FIG. 4. Such an approach is of advantage in that processing needed for optimization can be done at idle time rather than a critical boot-up time.

As a further optional refinement, the aforesaid log can be arranged to take into account temporal latencies exhibited by the processor 20 between requests for data; such temporal latencies are susceptible to being used advantageously to allow the controller to fill the data cache 320 with expected read requests from the media 200.

A yet further optional refinement is to a plurality of logs of multiple different boot-up sequences, for example as arise in a multi-boot computer system. In this refinement, a change to a different configuration of track sequences will interrupt a sequence of track accesses according to one log of the controller 310 adopted by the controller 310 and cause it to switch between other logs without loosing significant performance. In order to provide such switching between logs, the logs are preferably provided with defined jump points to allow the controller 310 to jump between them effectively and reliably without causing delay and data loss.

It will be appreciated that embodiments of the invention described in the foregoing are susceptible to being modified without departing from the scope of the invention.

The method of the invention described in the foregoing is capable of being extended to any repetitive access pattern that starts from a known state. For example, the method pertains not only to “wake-up” of the computer system 10 from a power-down state, but also from an idle, sleep or hibernation state. The method can even be extended to any repetitive access pattern like characteristic application start-up and shut-down sequences. Thus, the present invention is not merely limited to computer system boot-up.

Preferably, the method is implemented substantially buried within the hard disk drive 60 and therefore effectively transparent to the processor 20, thereby maintaining compatibility with earlier types of disk drive not implementing the method of the invention. Use of the method would, in practice, be determinable in that the system 10 is capable of booting-up more rapidly on subsequent boot-ups in comparison to an earlier boot-up in which the aforementioned log is first established.

It is also envisaged by the inventors that it is feasible to implement the method at least in part by using the processor 20 although such an implementation is perceived to be more difficult because of the nature of the boot-up implies that only limited knowledge and limited intelligence is available within the computer system 10 in early stages of boot-up.

The present invention is suitable for use in any type of apparatus including a form of computer system susceptible to a boot-up process. Such apparatus includes mobile telephones with miniature optical disk data storage facilities, in digital cameras employing miniature optical disk storage memories and portable audio-visual presentation apparatus, for example in personal audio entertainment apparatus such as interactive toys providing complex audio/visual presentation to its users.

In the foregoing, and also with regard to the appended claims, expressions such as “include”, “incorporate”, “contain”, “comprise”, “is” and “have” are to be construed non-exclusively, namely construed to allow for other items or components which are not explicitly disclosed also to be present.

1. A method of increasing boot-up speed in a computer system (10), comprising the steps of:
(a) arranging for the system (10) to include computing means (20) for processing data, and data storing means (60) coupled to the computing means (20) for providing data to and receiving data from the computing means (20), the storing means (60) being operable to write and/or read data in a plurality of spatially disposed regions of at least one data medium (200) thereof wherein access between the spatial regions is subject to one or more associated jump delays;
(b) arranging for the storing means (60) to including data caching means (320) therein for temporarily storing data read from and/or for writing data to said at least one data medium (200);
(c) on initial boot-up of the system (10), making at least one log of a temporal sequence in which one or more spatially disposed regions of the at least one data medium (200) are accessed; and
(d) on one or more subsequent boot-ups of the system (10), using the at least one log to store data read from the at least one data medium (200) temporarily in the data caching means (310, 320) so as to provide for a more temporally efficient sequence of accessing the spatially disposed regions so as to speed up said one or more subsequent boot-ups.

2. A method according to claim 1, further comprising a step of arranging for the system (10) to adopt an heuristic approach for accessing the spatially disposed regions when, on said one or more subsequent boot-ups, a sequence of accessing the spatially disposed regions instructed by the computing means digresses from that which is recorded in said at least one log.

3. A method according to claim 1, wherein there are several logs corresponding to a plurality of temporal sequences, and the method includes a further step of arranging for the system (10) to switch between the logs depending upon which of the temporal sequences the system elects to adopt on boot-up.

4. A method according to claim 3, wherein the system (10) is arranged to switch dynamically between the logs when executing boot-up.

5. A method according to claim 1, wherein the storing means (60) is implemented as at least one hard disk drive (HDD) provided with associated local computing means (310) for implementing the data caching means (320), for supervising recording of the one or more logs and for executing their one or more sequences in response to boot-up of the system (10).

6. A computer system (10) arranged to provide a more rapid boot-up, wherein:
(a) the system (10) includes computing means (20) for processing data, and data storing means (60) coupled to the computing means (20) for providing data to and receiving data from the computing means (20), the storing means (60) being operable to write and/or read data in a plurality of spatially disposed regions of at least one data medium (200) thereof wherein access between the spatial regions is subject to one or more associated jump delays;
(b) the storing means (60) includes data caching means (310, 320) therein for temporarily storing data read from and/or for writing data to said at least one data medium (200);
(c) the system (10) is operable on initial boot-up thereof to make at least one log of a temporal sequence in which one or more spatially disposed regions of the at least one data medium (200) are accessed; and
(d) the system (10) is operable, on one or more subsequent boot-ups thereof, to use the at least one log to store data read from the at least one data medium (200) temporarily in the data caching means (310, 320) so as to provide for a more temporally efficient sequence of accessing the spatially disposed regions so as to speed up said one or more subsequent boot-ups.

7. A system (10) according to claim 6, wherein the system (10) is further operable to adopt an heuristic approach for accessing the spatially disposed regions when, on said one or more subsequent boot-ups, a sequence of accessing the spatially disposed regions instructed by the computing means (20) digresses from that which is recorded in said at least one log.

8. A system (10) according to claim 6, arranged to record several logs corresponding to a plurality of temporal sequences, and arranged to switch between the logs depending upon which of the temporal sequences the system (10) elects to adopt on boot-up.

9. A system (10) according to claim 8, arranged to switch dynamically between the logs when executing boot-up.

10. A system (10) according to claim 6, wherein the storing means (60) is implemented as at least one hard disk drive (HDD) provided with associated local computing means (310) for implementing the data caching means (310, 320), for supervising recordation of the one or more logs and for executing their one or more sequences in response to boot-up of the system (20).

11. A hard disk drive (60) for use in a computer system (10) to provide a more rapid boot-up therein, wherein:
(a) the system (10) includes computing means (20) for processing data, and the disk drive (60) coupled to the computing means (20) for providing data to and receiving data from the computing means (20), the disk drive (60) being operable to write and/or read data in a plurality of spatially disposed regions of at least one data medium (200) thereof wherein access between the spatial regions is subject to one or more associated jump delays;
(b) the disk drive (60) includes data caching means (310, 320) therein for temporarily storing data read from and/or for writing data to said at least one data medium (200);
(c) the system (10) is operable on initial boot-up thereof to make at least one log of a temporal sequence in which one or more spatially disposed regions of the at least one data medium (200) are accessed; and
(d) the system (10) is operable, on one or more subsequent boot-ups thereof, to use the at least one log to store data read from the at least one data medium (200) temporarily in the data caching means (310, 320) so as to provide for a more temporally efficient sequence of accessing the spatially disposed regions so as to speed up said one or more subsequent boot-ups.
